(19) United States
(12) Patent Application Publication
(10) Pub. No.: US 2009/0051548 A1
(43) Pub. Date: Feb. 26, 2009

(54) Pet Alert Device

(76) Inventor: Derek Dundon, Sussex, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/843,097

(22) Filed: Aug. 22, 2007

(51) Int. Cl. G08B 23/00

(52) U.S. Cl. 340/573.3

(57) ABSTRACT

A device for alerting a pet owner that the pet wants to be let outside comprised of: a housing having at least one side surface and a bottom surface; at least one movable plate, each movable plate movable between a first position where no pressure is applied to it and a second position where under a pressure, the movable plate is moved toward the bottom surface of the housing; and at least one biasing member for maintaining the movable plate in the first position when said at least one movable plate is not under pressure such that when said at least one movable plate is depressed, a pre-recorded message is emitted from the device. The device can be mounted to a wall, door, or doorframe, either directly or using a mounting unit, or can be placed on the floor.

### FIELD OF INVENTION

This invention relates generally to the field of a pet alert and training device, and in particular to the field of a device that allows a pet to alert the pet's owner that the pet needs to be let outside.

### BRIEF DESCRIPTION OF THE DRAWINGS

FIG. 1 shows a cross-sectional view of one embodiment of the pet alert device.

FIG. 2 shows the embodiment of pet alert device shown in FIG. 1 mounted on a door and in use.

FIG. 3 shows a schematic of one embodiment of a circuit diagram for the pet alert device.

FIG. 4 shows a top perspective view of the embodiment of the pet alert device shown in FIG. 1.

FIG. 5 shows a top perspective view of an alternate embodiment of the pet alert device.

### BACKGROUND

There are approximately 50,000,000 (fifty million) households in the United States that have a dog and approximately 60,000,000 (sixty million) households that have cats.

Often when a pet dog or cat (or other animal) wishes to be let out of a house, it may either stand silently by the door waiting for the owner to come by and open the door or it may bark or even scratch at the door. Where the dog merely waits silently at the door, it may wait a long period of time before the owner happens to come by and see the dog. Even if the dog does bark, the owner may hear the dog but may confuse the barking with other barking the dog may do if the dog tends to bark a lot. The owner may also find the barking to be annoying to others. Scratching of the door clearly is undesirable as it can cause damage to the door.

As used herein, the terms “pet” and “animal” refer to any domesticated animal that can be kept within a household.

As used herein, the term “structure” refers to a door, door frame, wall, or any other object to which the pet alert device or mounting unit can be attached.

As used here, the term “biasing member” refers to any object or construction that maintains the movable plate in a first position when not in use, but allows the movable plate to move to a second position when subject to a downward force against the movable plate. Examples of biasing members include flexible tubes, levers, springs (such as star springs with a memory, sponges, geo springs), pressure sensitive device electronic devices adapted to receive pressure input, and combinations thereof.

As used herein, the term “pre-recorded message” includes a user-recorded message, a user selected or defined message, a stored message, multiple stored or recorded messages, and a recognizable or expressive sound (such a siren, drum roll, musical expression music, or song lyrics).

### DETAILED DESCRIPTION OF EMBODIMENTS OF THE INVENTION

For the purpose of promoting an understanding of the present invention, references are made in the text hereof to embodiments of a pet alert device, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar materials from which the pet alert device is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near indentical structural elements.

Moreover, the term “substantially” or “approximately” as used herein may be applied to modify any quantitative representation that could permissibly vary without resulting in a change in the basic function to which it is related. For example, one embodiment of the pet alert device is disclosed herein as being disc-shaped (i.e., circular when viewed from above). The pet alert device might permissibly be somewhat non-disc-shaped and still be within the scope of the invention if its functionality is not materially altered.

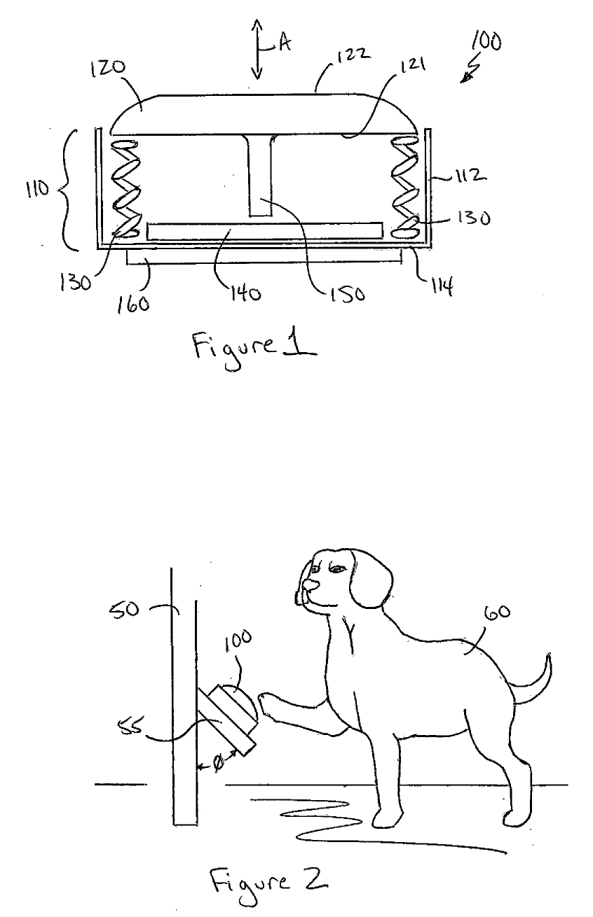

Referring now to the drawings, FIG. 1 shows a cross-sectional view of one embodiment of the pet alert device 100. The embodiment of pet alert device 100 is comprised of housing 110, movable plate 120, biasing members 130, printed circuit board 140, protrusion 150, and adhesive 160.

Housing 110 is comprised of side surface 112 and bottom surface 114. In the embodiment shown, housing 110 is circular as viewed from above and approximately three and three-quarter inches (3¾″) wide and approximately one and one-quarter inches (1¼″) tall. Thus, pet alert device 100 is of sufficient size to allow a pet (not shown) to use pet alert device 100 while minimizing the size and bulk of pet alert device 100. In the embodiment shown, housing is made of plastic, but can be made of almost any alternate material commonly known and used in the art, including metal, wood, rubber, and combinations thereof.

Also visible in FIG. 1 is movable plate 120. Movable plate 120 is disc-shaped and includes top surface 122 and bottom surface. Movable plate 120 includes protrusion 150 positioned on its bottom surface 121 and is movable between two (2) positions, along arrow A. In the first position (as shown), movable plate 120 is at rest and ready to be activated. In the second position, movable plate 120 is depressed along arrow A, toward bottom surface 114 of housing 110. When a pet depresses movable plate 120, protrusion 150 also moves downward, completing an electrical circuit (described in detail with respect to FIG. 3) to provide an audio alert. Thus, the pet is able to operate pet alert device 100 to alert the owner that it wishes to be let outside. In the embodiment shown, movable plate 120 is made of plastic, but can also be made of made of almost any alternate material commonly known and used in the art, including metal, wood, rubber, and combinations thereof. In an alternate embodiment of pet alert device 100, the audio alert is not triggered by the pet pressing down on movable plate 120, but by either a motion sensor (not shown) or a trip wire (not shown). In such an embodiment, pet alert device would include the additional component, i.e., a trip wire or motion sensor, and accompanying circuitry to allow the audio alert to be initiated upon pet alert device 100 detecting motion or the wire being pulled.

Also visible in FIG. 1 are biasing members 130. Biasing members 130 exert an upward force on movable plate 120 so that the electrical circuit is not completed when pet alert device 100 is not activated. Biasing members 130 must support the weight of movable plate 120, but still allow movable plate 120 to be moved downward when subject to a downward force such as a dog's paw. In the embodiment shown, biasing members 130 are two (2) springs, but can alternately be a flexible tube, a star spring with a memory, a sponge, a geo spring, or combinations thereof. In addition, the embodiment of pet alert device 100 includes two (2) biasing members 130. However, any number of biasing members can be used, including one (1), that provides sufficient upward force to support movable plate 120 but allow movable plate 120 to easily be overcome.

Also visible in the embodiment of pet alert device 100 shown in FIG. 1 is printed circuit board 140 (PCB). PCB 140 provides a surface on which the electronics (described in detail with respect to FIG. 3) of pet alert device 100 can be placed. In the embodiment shown, PCB 140 is horizontally positioned on the inside surface of bottom surface 114 of housing 110. However, PCB 140 can be placed anywhere within housing 110. In addition, PCB 140 can be positioned vertically or be comprised of multiple PCBs 140, which may be necessary for additional features or to fit all of the necessary and/or optional components of pet alert device 100 within housing 110.

Finally, also visible in FIG. 1 is adhesive layer 160. Adhesive layer 116 is positioned on bottom surface 114 of housing and allows pet alert device 100 to be temporarily secured in position, whether to the floor, door, door frame, wall, or other location, parallel with the floor, door, door frame, or wall. However, it should be understood that pet alert device 100 need not include adhesive layer 160. For example, one (1) embodiment of pet alert device 100 can be placed on the floor near a doorway. In such a use of pet alert device 100, pet alert device 100 can include adhesive layer 160 to keep it in place or pet alert device 100 can exclude adhesive layer 160, allowing it to be easily moved. In addition, pet alert device 100 can include alternate ways to secure pet alert device 100 in place. For example, pet alert device 100 can be mounted to a door, a doorframe, or to the wall near the door. In such an embodiment, pet alert device 100 can be temporarily or permanently secured in place by glue, a hook and latch mechanism, nails, screws, suction cups, or other means commonly employed in the art. Housing 110 could include one (1) or more apertures that allows it to be secured to the door, doorframe, or wall. In addition, a separate frame can be mounted, permanently or temporarily, to the door, doorframe, or wall, and include a recess into which pet alert device 100 can be placed, allowing a convenient, but easily removable pet alert device 100.

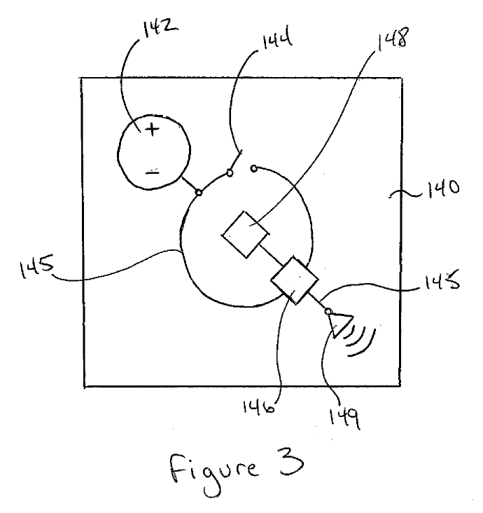

FIG. 2 shows the embodiment of pet alert device 100 shown in FIG. 1 mounted on door 50 and in use. As can be appreciated, pet alert device 100 can be mounted to door 50 using mounting unit 55, with pet alert device 100 temporarily secured to mounting unit 55 using screws, bolts or an adhesive (not shown). Mounting unit 55 provides a place on which pet alert device 100 can be mounted, permanently or temporarily (as provided supra), but at angle φ. By positioning mounting unit 55 at angle φ, it is easier for dog 60 to operate pet alert device 100. In the embodiment shown, mounting unit 55 and pet alert device 100 are at a thirty degree (30°) angle from vertical, but can be mounted at any angle between approximately twenty degrees (20°) and approximately seventy degrees (70°). In addition, although pet alert device 100 and mounting unit 55 are shown as being mounted to door 50, mounting unit 55 can alternately be mounted to a doorframe (not shown) or a wall (also not shown) adjacent to or near door 50 or any other convenient location.

FIG. 3 shows a schematic of one (1) embodiment of a circuit diagram for the pet alert device. In the embodiment shown, the electronic circuitry is comprised of power source 142, switch 144, microprocessor 146, recording unit 148, and speaker 149, all interconnected by wires 145 and positioned on the top surface of printed circuit board (PCB) 140.

In the embodiment shown, power source 142 is a watch battery. However, power source 142 can be any type of power source that can be positioned within the pet alert device (including a DC power supply, battery, or solar power storage device).

Switch 144 allows the pet alert device to sit dormant until activated. Once the pet depresses the movable plate (not shown), the switch 144 closes, completing the circuit and allowing the pet alert device to emit the audible alert to the animal's owner. In the embodiment shown, the movable plate includes a protrusion (not shown). When depressed, the protrusion closes switch 144, completing the circuit. It should be understood that any type of switch and any mechanism for completing the circuit when the movable plate is depressed commonly known and used in the art could be employed.

Also visible in FIG. 3 is microprocessor 146. Microprocessor 146 stores at least one (1) pre-recorded message. For example, one (1) embodiment of microprocessor 146 has five (5) pre-recorded messages saved therein, such as a human's voice saying, “Hey, I'm about to make a mess here,” and “Could someone please let me outside?” as well as three (3) others. When the movable plate is depressed, microprocessor 146 randomly selects one (1) of the pre-recorded messages and plays it. One (1) common embodiment of microprocessor 146 is capable of storing approximately thirty (30) seconds of pre-recorded messages. In such an embodiment, each pre-recorded message would be between five (5) and six (6) seconds long. The pre-recorded message can be in a male or female voice and can have a humorous or serious voice. Alternate embodiments of the pet alert device can store alternate audio alerts, such as a siren, music, or song lyrics. In another embodiment, microprocessor 146 is capable of receiving and storing a message or sound input by the user. In yet another embodiment, a user may program or select a sequence of one (1) or messages from a menu of messages.

In the embodiment described immediately supra, the pet alert device is constructed with the pre-recorded message(s) already saved on microprocessor 146. However, in an alternate embodiment, as shown in FIG. 3, PCB 140 further includes recording unit 148. Recording unit 148 allows the user of the pet alert device to record their own personal message(s) into the pet alert device, creating a more personal and unique message.

Also visible in FIG. 3 is speaker 149. Speaker 149 provides a means by which the prerecorded message(s) can be emitted from the pet alert device and heard by the pet's owner. In the embodiment shown, the pre-recorded message can be heard at a distance of approximately twenty to thirty feet (20′-30′) away. However, speaker 149 can be of any type commonly known and used in the art and can be changed to allow the pre-recorded message(s) to be heard at greater distances or only at shorter distances. In addition, in an alternate embodiment of the dog alert system, PCB 140 can also include a volume control unit (not shown).

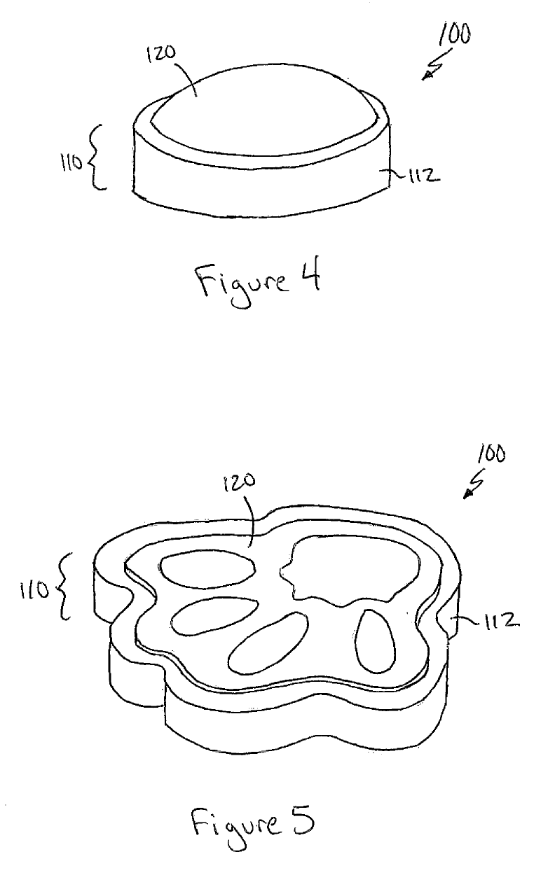

FIG. 4 shows a top perspective view of the embodiment of pet alert device 100 shown in FIG. 1. As can be appreciated, pet alert device 100 is disc-shaped, being circular when viewed from above. However, it should be understood that pet alert device 100 could be constructed in alternate shapes, including square, hexagonal, elliptical, etc., and can be asymmetrically or irregularly shaped as well.

FIG. 5 shows a top perspective view of an alternate embodiment of pet alert device 100 in the shape of an animal's paw. Such an embodiment is more decorative and memorable in the eyes of a consumer. In addition, whether pet alert device 100 is disc-shaped (as shown in FIGS. 1, 2, and 4), in the shape of a paw (as shown in FIG. 5), or another shape, movable plate 120 can further include a decoration or advertising logo or message on its top surface. For example, Purina®, Kibbles 'n Bits®, Iams®, or another pet-related company can place their trademarks or logos on pet alert device 100 as part of a promotional campaign, as well as those unrelated to pets, such as a sports team, a hospital, or a retail store, as just a few examples. Furthermore, any decorative indicia can be placed on pet alert device 100. Pet alert device 100 can also be made of any color or pattern, regardless of whether any decorative indicia are placed on pet alert device 100.

While the pet alert device has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A device comprised of:
a housing, said housing having at least one side surface and a bottom surface;
at least one movable plate, each of said at least one movable plate movable between a first position where no pressure is applied to said at least one movable plate and a second position where under a pressure, said at least one movable plate is moved toward said bottom surface of said housing;
at least one biasing member, said biasing member maintaining said at least one movable plate in said first position when said at least one movable plate is not under said pressure; and
wherein when said at least one movable plate is depressed, one of at least one pre-recorded message is emitted from said device.

2. The device of claim 1, wherein said device is constructed in a shape selected from a group comprised of a disc, a bone, a paw, a dog accessory, and a dog-related symbolic representation.

3. The device of claim 1, wherein said at least pre-recorded message is selected from a group comprised of a human voice, a siren, a segment of music, and song lyrics.

4. The device of claim 1, wherein said housing and said at least one movable plate are made of a material selected from a group comprised of plastic, metal, wood, rubber, and combinations thereof.

5. The device of claim 1, wherein said biasing member is selected from a group comprised of a flexible tube, a lever, a spring, a pressure sensitive device, an electronic device adapted to receive pressure input, and combinations thereof.

6. The device of claim 1, wherein said device further includes a printed circuit board positioned within said housing, said printed circuit board positioned supporting, at least one power source, at least one switch, a microprocessor for storing said at least one pre-recorded message, a speaker for emitting said at least one pre-recorded message, and at least one wire electrically connecting said at least one power source, said at least one switch, said microprocessor, and said speaker.

7. The device of claim 6, wherein said device further includes at least one additional component supported by said printed circuit board, said at least one additional component selected from a group comprised of a recording unit, a volume control, a motion sensor, and a trip wire, and said at least one additional component electrically connected to said at least one power source, said at least one switch, said microprocessor, and said speaker.

8. The device of claim 1, wherein said device is adapted to be mounted to a structure.

9. The device of claim 1, wherein said device further includes a mounting unit, said mounting unit adapted to mount said device to a structure at an angle.

10. A pet alert device comprised of:
a housing, said housing having at least one side surface and a bottom surface;
at least one movable plate, each of said at least one movable plate movable between a first position where no pressure is applied to said at least one movable plate and a second position where under a pressure, said at least one movable plate is moved toward said bottom surface of said housing;
at least one biasing member, said biasing member maintaining said at least one movable plate in said first position when said at least one movable plate is not under said pressure; and
a printed circuit board, said printed circuit board positioned within said housing and supporting:
at least one power source
at least one switch;
a microprocessor for storing at least one pre-recorded message;
a speaker for emitting said at least one pre-recorded message; and
at least one wire electrically connecting said at least one power source, said at least one switch, said microprocessor, and said speaker;
wherein when said at least one movable plate is depressed, one of said at least one pre-recorded message is emitted from said pet alert device.

11. The pet alert device of claim 10, wherein said pet alert device is constructed in a shape selected from a group comprised of a bone, a paw, a dog accessory, and a dog-related symbolic representation.

12. The pet alert device of claim 10, wherein said housing and said at least one movable plate are made of a material selected from a group comprised of plastic, metal, wood, rubber, and combinations thereof.

13. The pet alert device of claim 10, wherein said biasing member is selected from a group comprised of a flexible tube, a lever, a spring, a pressure sensitive device, an electronic device adapted to receive pressure input, and combinations thereof.

14. The pet alert device of claim 10, wherein said pet alert device further includes at least one additional component supported by said printed circuit board, said at least one additional component selected from a group comprised of a recording unit, a volume control, a motion sensor, and a trip wire, and said at least one additional component electrically connected to said at least one power source, said at least one switch, said microprocessor, and said speaker.

15. The pet alert device of claim 10, wherein said pet alert device is adapted to be mounted to a structure.

16. The pet alert device of claim 10, wherein said pet alert device further includes a mounting unit, said mounting unit adapted to mount said pet alert device to a structure at an angle.

17. A device comprised of:
a housing, said housing having at least one side surface and a bottom surface;
at least one movable plate, each of said at least one movable plate movable between a first position where no pressure is applied to said at least one movable plate and a second position where under a pressure, said at least one movable plate is moved toward said bottom surface of said housing;
at least one biasing member, said biasing member maintaining said at least one movable plate in said first position when said at least one movable plate is not under said pressure;
a printed circuit board, said printed circuit board positioned within said housing and supporting:
at least one power source
at least one switch;
a microprocessor for storing at least one pre-recorded message;
a speaker for emitting said at least one pre-recorded message; and
at least one wire electrically connecting said at least one power source, said at least one switch, said microprocessor, and said speaker; and
a mounting unit, said mounting unit adapted to mount said device to a structure at a non-horizontal and non-vertical position;
wherein when said at least one movable plate is depressed, one of said at least one pre-recorded message is emitted from said device.

18. The device of claim 17, wherein said device is constructed in a shape selected from a group comprised of a disc, a bone, a paw, a dog accessory, and a dog-related symbolic representation.

19. The device of claim 17, wherein said housing and said at least one movable plate are made of a material selected from a group comprised of plastic, metal, wood, rubber, and combinations thereof.

20. The device of claim 17, wherein said biasing member is selected from a group comprised of flexible tube, lever, spring, a pressure sensitive device, an electronic device adapted to receive pressure input, and combinations thereof.

21. The device of claim 17, wherein said device further includes at least one additional component supported by said printed circuit board, said at least one additional component selected from a group comprised of a recording unit, a volume control, a motion sensor, and a trip wire, and said at least one additional component electrically connected to said at least one power source, said at least one switch, said microprocessor, and said speaker.
